(19) United States
(12) Patent Application Publication
(10) Pub. No.: US 2010/0003644 A1
(43) Pub. Date: Jan. 7, 2010

(54) Stamp Off

(75) Inventor: Debra Levy, Stafford, VA (US)

Correspondence Address: Tara Taffera, 385 Garrisonville Rd. # 116, Stafford, VA, 22554, US

(73) Assignee: Debra Levy, Stafford, VA (US)

(21) Appl. No.: 12/150,334

(22) Filed: Jul. 3, 2008

(51) Int. Cl. G09B 11/00

(52) U.S. Cl. 434/81

(57) ABSTRACT

A live, in person, card making and scrapbooking competition does not currently exist. The fact that there are live judges to judge the event also makes this a “new” idea not currently in existence. Contestants will have the opportunity to make handcrafted cards or scrapbook pages through the use of rubber stamping and others techniques, be judged by in-person judging, and winners will receive a prize.

The Stamp Off is the name of a live competition to be held in person.

There will be two types of participants-those who compete in the event and those who watch the event. There may be a separate admission fee for attendees and competitors. Contestants will have an entry fee to compete. Spectators will have a nominal fee to view the competition.

There will also be sponsors of the event. Admission for them will be complimentary as part of their sponsorship package. Anther benefit for sponsors is they will have a complimentary tabletop exhibit to display their products for participants.

There will also be judges to judge the live event.

Contestants will be hobbyists and/or professionals who make handcrafted cards and/or scrapbook pages through the use of rubber stamping and others techniques. Contestants may also include those who make scrapbook pages through the use of rubber stamping techniques.

In the competition, there will be various categories, all related to making cards and scrapbook pages through the use of rubber stamping.

Winners in each of the categories will receive a prize. There will be different levels to the competition including beginner, intermediate and advanced, based on the number of years of experience of participants.

The categories of competition will utilize assorted stamping techniques. Categories may include the following but are not limited to these categories.

Categories:

Best use of one stamp set

Most creative card (unique usage of standard tools)

Most creative scrapbook page

Best use of watercolors

Best use of paper

Best card with one-ink color

Best holiday card

Best in Show

1. We claim that a live, in-person card-making and scrapbooking competition with on-site judges as described in detail in the specification does not exist currently.
